(19) United States
(12) Patent Application Publication
(10) Pub. No.: US 2022/0199063 A1
(43) Pub. Date: Jun. 23, 2022

(54) SOUND-ABSORBING MATERIAL

(71) Applicant: ENEOS CORPORATION, Tokyo (JP)

(72) Inventors: Kunihiko IBAYASHI, Tokyo (JP); Tomoyuki OKAMURA, Tokyo (JP); Hirofumi AIZONO, Tokyo (JP); Takashi OKABE, Tokyo (JP); Masako KOSHIKAWA, Tokyo (JP)

(73) Assignee: ENEOS CORPORATION, Tokyo (JP)

(21) Appl. No.: 17/600,814

(22) PCT Filed: Mar. 19, 2020
(86) PCT No.: PCT/JP2020/012344

§ 371 Date: Oct. 1, 2021

(30) Foreign Application Priority Data
Apr. 3, 2019 (JP) 2019-071513

(51) Int. Cl. G10K 11/168; B32B 5/26; D04H 1/559

(52) U.S. Cl. CPC G10K 11/168; B32B 5/266; D04H 1/559; D10B 2331/04; B32B 2262/0276; B32B 2262/16; B32B 2262/144; B32B 2307/102

(57) ABSTRACT

The sound absorbing material 50 comprises: a felt-like fiber body 51 which includes 15 to 70% by weight of fine fibers with a fineness of 1 denier or less, 20 to 60% by weight of hollow fibers having inner cavities, and 10 to 40% by weight of binder fibers that join the fibers together; and a nonwoven fabric 52 that is laminated on a surface of the felt-like fiber body 51. The nonwoven fabric 52 includes a plurality of drawn long fibers arranged and oriented in one direction. An average diameter of the plurality of long fibers is in the range of 1 to 4 μm. The sound absorbing material 50 has a thickness in the range of 8 to 45 mm and a bulk density of 20 kg/m³ or less.

### TECHNICAL FIELD

The present invention relates to a sound absorbing material having a felt-like fiber body (porous sound absorber) and a nonwoven fabric that is laminated on a surface of the felt-like fiber body.

### BACKGROUND ART

The applicant has previously proposed a nonwoven fabric for sound absorbing application adapted to be laminated on a porous sound absorber (see Patent Document 1). The nonwoven fabric for sound absorbing application includes a plurality of drawn long fibers arranged and oriented in one direction. The mode value of the diameter distribution of these long fibers is in the range of 1 to 4 μm. The nonwoven fabric for sound absorbing application can improve the sound absorption performance in the frequency band of 1000 to 10000 Hz as compared to the porous sound absorbing material alone, and still remains light in weight and flexible enough to be substantially comparable to the porous sound absorber.

### REFERENCE DOCUMENT LIST

### Patent Document

Patent Document 1: JP 2018-092131 A

### SUMMARY OF THE INVENTION

### Problem to be Solved by the Invention

Combining the nonwoven fabric for sound absorbing material with a porous sound absorber can yield a sound absorbing material with improved sound absorption performance in the frequency band of 1000 to 10000 Hz as compared to the porous sound absorber alone. However, high sound absorption performance is not always required in the entire frequency range of 1000 to 10000 Hz, and high sound absorption performance may be required in a specific frequency band of 10000 Hz or less (for example, 2000 to 3000 Hz, or 5000 to 6000 Hz). Furthermore, when the sound absorbing material is made into a product, it is required to be easily manufactured, light in weight, and easy to handle.

In view of the above, the present invention has been made to provide a sound absorbing material which is light in weight, easy to handle, provides high sound absorption performance in a predetermined frequency band of 10000 Hz or less, and is easy to manufacture.

### Means for Solving the Problem

The present inventors found, as a result of repeated research and experiments, a sound absorbing material which is light in weight, is excellent in handling, provides high sound absorption performance in a predetermined frequency band of 10000 Hz or less, and can be manufactured relatively easily by combining the nonwoven fabric for sound absorbing material having a specific grammage with a specific porous sound absorber. The present invention has been made based on this finding.

The sound absorbing material according to the present invention comprises a felt-like fiber body, and a nonwoven fabric that is laminated on a surface of the felt-like fiber body.

The felt-like fiber body includes 15 to 70% by weight of fine fibers with a fineness of 1 denier or less, 20 to 60% by weight of hollow fibers having inner cavities, and 10 to 40% by weight of binder fibers that join the fibers together. The nonwoven fabric includes a plurality of drawn long fibers arranged and oriented in one direction, and has an average diameter of the plurality of long fibers in the range of 1 to 4 μm and a grammage in the range of 5 to 20 g/m². The sound absorbing material has a thickness in the range of 8 to 45 mm and a bulk density of 20 kg/m³ or less.

### Effects of the Invention

The present invention provides a sound absorbing material which is light in weight, easy to handle, capable of providing high sound absorption performance in a predetermined frequency band of 10000 Hz or less, and easy to manufacture.

### BRIEF DESCRIPTION OF THE DRAWINGS

FIG. 1 is a cross-sectional view of a sound absorbing material according to an embodiment of the present invention.

FIG. 2 is an enlarged photograph (1000× magnification) of an example of a nonwoven fabric constituting the sound absorbing material, photographed by a scanning electron microscope.

FIG. 3 is a view showing a schematic configuration of an example of a manufacturing apparatus of a longitudinally oriented filament nonwoven fabric, which is an example of the nonwoven fabric.

FIG. 4 is a view showing a schematic configuration of an example of a manufacturing apparatus of the sound absorbing material.

FIG. 5 is a table showing the physical properties of the longitudinally oriented filament nonwoven fabric.

FIG. 6 shows the filament diameter distribution of the longitudinally oriented filament nonwoven fabric.

FIG. 7 is a table showing characteristic values (thickness, grammage, bulk density) of Examples 1 to 5 (sound absorbing material).

FIG. 8 is a table showing a mixing ratio of PET fine fibers, hollow PET fibers, and low-melting point PET fibers in the felt-like fiber body of Examples 1 to 5.

FIG. 9 is a graph showing the measurements of the normal incident sound absorption coefficient for Examples 1 to 5 (sound absorbing material).

FIG. 10 is a graph showing the measurements of the normal incident sound absorption coefficient for Comparative Examples 1 to 5 (felt-like fiber body).

### MODE FOR CARRYING OUT THE INVENTION

Hereinafter, an embodiment of the present invention will be described.

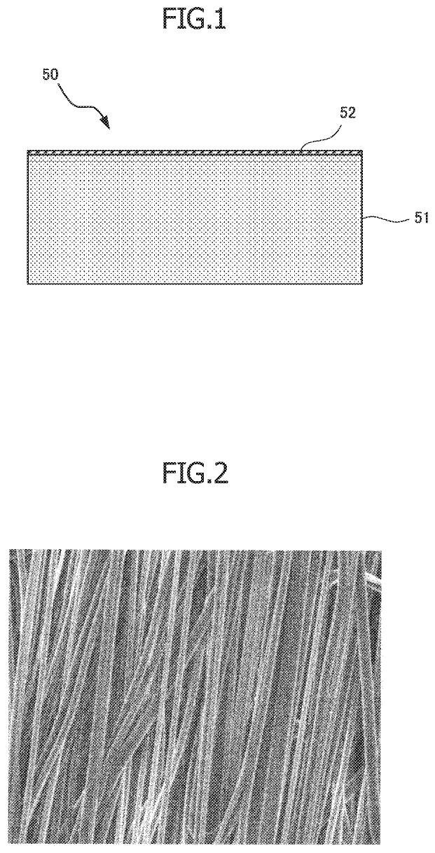

FIG. 1 is a cross-sectional view of the sound absorbing material according to an embodiment of the present invention. As shown in FIG. 1, the sound absorbing material 50 according to the present embodiment has a felt-like fiber body 51 as the porous sound absorber and a nonwoven fabric 52 that is laminated on the surface of the felt-like fiber body 51. The felt-like fiber body 51 and the nonwoven fabric 52 are integrated to constitute the sound absorbing material 50.

### Felt-Like Fiber Body 51

The felt-like fiber body 51 is formed by blending (mixing) the fine fibers having a fineness of 1 denier or less, hollow fibers having inner cavities, and binder fibers that join the fibers together. The fine fibers, hollow fibers and binder fibers are thermoplastic resin fibers. Although not particularly limited, the fine fibers, hollow fibers, and binder fibers are preferably polyester resin fibers mainly containing a polyester (in particular, a polyethylene terephthalate) or polypropylene resin fibers mainly containing a polypropylene.

The fineness of the fine fibers is preferably 0.3 to 1.0 denier. That is, the fine fibers may be so-called ultrafine fibers. The mixing rate (mixing ratio) of the fine fibers in the felt-like fiber body 51 is 15 to 70% by weight, preferably 20 to 50% by weight. If the mixing rate of the fine fibers is less than 15% by weight, it becomes difficult to secure the sound absorption performance, and if the mixing rate of the fine fibers exceeds 70% by weight, bulkiness and flexibility may not be obtained.

The fineness of the hollow fibers is greater than that of the fine fibers and is 15 denier or less, preferably 2 to 10 denier. The mixing rate of the hollow fibers in the felt-like fiber body 51 is 20 to 60% by weight, preferably 30 to 50% by weight. If the mixing rate of the hollow fibers is less than 20% by weight, sufficient bulkiness and flexibility cannot be obtained, and if the mixing rate of the hollow fibers exceeds 60% by weight, the sound absorption performance can hardly be improved, the cost is increased and thus it is not economical. Note that although not particularly limited, the felt-like fiber body 51 (and by extension to the sound absorbing material 50) having excellent bulkiness and flexibility can be obtained by increasing the mixing rate of the hollow fibers than that of the fine fibers within the above range, that is, increasing the mixing ratio of the hollow fibers to be greater than that of the fine fibers.

The binder fibers have a lower melting point than the fine fibers and hollow fibers, and they are melted by heat treatment so that the fibers constituting the felt-like fiber body 51 are joined together. The binder fibers may also contribute to integrating the felt-like fiber body 51 with the nonwoven fabric 52, that is, join the felt-like fiber body 51 and the nonwoven fabric 52. The fineness of the binder fibers is greater than that of the fine fibers and is 6 denier or less, preferably 2 to 5 denier. The mixing rate of the binder fibers in the felt-like fiber body 51 is 10 to 40% by weight, preferably 25 to 35% by weight. If the mixing rate of the binder fibers is less than 10% by weight, it may result in insufficient joining of the fibers constituting the felt-like fiber body 51 and so as joining of the felt-like fiber body 51 and the nonwoven fabric 52, and if the mixing rate of the binder fibers exceeds 40% by weight, the flexibility of the felt-like fiber body 51 may be impaired.

The felt-like fiber body 51 is manufactured through the same steps as the standard felt is manufactured. That is, the felt-like fiber body 51 is manufactured through the steps such as the step of mixing (blending) the fine fibers, the hollow fibers, and the binder fibers to obtain mixed fibers (mixing step), the step of opening and carding the mixed fibers to form a mixed fiber web (carding step), and the step of laminating the formed mixed fiber web to form a web laminate (laminating step). The web laminate is heat-treated, as will be described later.

The grammage of the felt-like fiber body 51 is in the range of 100 to 500 g/m², and the thickness of the felt-like fiber body 51 is in the range of 8 to 45 mm

### Nonwoven Fabric 52

The nonwoven fabric 52 is a so-called long-fiber nonwoven fabric. The nonwoven fabric 52 includes a plurality of drawn long fibers (filaments) arranged and oriented in one direction.

For example, the nonwoven fabric 52 may be a “unidirectionally oriented nonwoven fabric”, which includes a plurality of drawn long fibers arranged and oriented in one direction. As used herein, the “one direction” does not necessarily refer strictly to a single direction, but merely refers to being substantially in a single direction. The “unidirectionally oriented nonwoven fabric” as described above may be manufactured through manufacturing steps including the step of arranging and orienting a plurality of long fibers in one direction, and the step of drawing the plurality of arranged and oriented long fibers in the one direction, for example.

As used herein, “arranging and orienting a plurality of long fibers in one direction” indicates arranging and orienting the plurality of long fibers so that the length direction (axial direction) of each long fiber coincides with the one direction, that is, so that the arranged and oriented long fibers extend substantially in the one direction. For example, when the unidirectionally oriented nonwoven fabric is manufactured in a long sheet form, the one direction may be the lengthwise direction (also referred to as “longitudinal direction”) of the long sheet, or a direction inclined with respect to the lengthwise direction of the long sheet, or the width direction (also referred to as “transverse direction”) of the long sheet, or a direction inclined with respect to the transverse direction of the long sheet.

Also as used herein, “drawing the plurality of arranged and oriented long fibers in the one direction” indicates drawing each of the plurality of long fibers substantially in its axial direction. By drawing the plurality of long fibers in one direction after arranging and orienting the long fibers in the one direction, molecules in each long fiber are oriented in the one direction in which the long fiber is drawn, that is, in the axial direction of the long fiber.

FIG. 2 is an enlarged photograph (1000× magnification) of the unidirectionally oriented nonwoven fabric which is an example of the nonwoven fabric 52. In the unidirectionally oriented nonwoven fabric shown in FIG. 2, long fibers are oriented substantially in the up-down direction of FIG. 2.

In addition to the drawn long fibers arranged and oriented in one direction (first long fibers), the nonwoven fabric 52 may further include second long fibers that are drawn long fibers arranged and oriented in a direction orthogonal to the one direction. In other words, the nonwoven fabric 52 may be an “orthogonally oriented nonwoven fabric”, which includes a plurality of drawn long fiber filaments arranged and oriented in two directions that are orthogonal to each other. As used herein, these two “orthogonal” directions do not have to be strictly orthogonal, but have merely to be substantially orthogonal. The orthogonally oriented nonwoven fabric as described above is obtained, for example, by stacking and fusing two sheets of a unidirectionally oriented nonwoven fabric together in an arrangement in which long fibers in one of these two sheets are orthogonal to long fibers in the other.

Here, the nonwoven fabric 52 will be specifically described. As described above, the nonwoven fabric 52 may be either the “unidirectionally oriented nonwoven fabric” or the “orthogonally oriented nonwoven fabric”. In the following description, the term “longitudinal (direction)” may refer to the feed direction of the nonwoven fabric 52 during manufacture (i.e., corresponding to the length direction of the nonwoven fabric). The term “transverse (direction)” may refer to a direction orthogonal to the feed direction (i.e., corresponding to the width direction of the nonwoven fabric 52). Hereafter, the long fibers may also be referred to as filaments.

### Unidirectionally Oriented Nonwoven Fabric (Longitudinally Oriented Filament Nonwoven Fabric)

A longitudinally oriented filament nonwoven fabric, which is an example of the unidirectionally oriented nonwoven fabric, is obtained by orienting a plurality of long fibers made of a thermoplastic resin in the longitudinal direction, that is, so that the length direction (axial direction) of each long fiber substantially coincides with the longitudinal direction, and drawing these oriented long fibers in the longitudinal direction (axial direction). In the longitudinally oriented filament nonwoven fabric, molecules in each long fiber are oriented in the longitudinal direction. Here, the longitudinal drawing ratio of each of the long fibers is in the range of 3 to 6. Furthermore, the average diameter of the long fibers constituting the longitudinally oriented filament nonwoven fabric (i.e., the long fibers after drawing) is in the range of 1 to 4 μm, preferably in the range of 2 to 3 μm. Furthermore, the variation coefficient of the diameter distribution of the long fibers constituting the longitudinally oriented filament nonwoven fabric is in the range of 0.1 to 0.3. Here, the variation coefficient is obtained by dividing the standard deviation of the diameters of the long fibers by the average of the diameters (average filament diameter).

The long fibers are not particularly limited. For example, the long fibers may have an average length greater than 100 mm. Furthermore, the long fibers have merely to have an average diameter in the range of 1 to 4 μm. The longitudinally oriented filament nonwoven fabric may additionally contain long fibers having a diameter less than 1 μm and/or long fibers having a diameter greater than 4 μm. The length and diameter of the long fibers can be measured using, for example, an enlarged photograph of the longitudinally oriented filament nonwoven fabric photographed by a scanning electron microscope. Specifically, the average diameter, the standard deviation and the variation coefficient can be calculated from N (50, for example) measurements of the filament diameters.

The grammage of the longitudinally oriented filament nonwoven fabric is in the range of 5 to 20 g/m², preferably about 15 g/m² (for example, 15±3 g/m²). If the grammage is less than 5 g/m², the strength may be insufficient. On the other hand, if the grammage exceeds 20 g/m², the thickness increases and the air permeability decreases. This is likely to generate places where hot air cannot easily pass through at the time the longitudinally oriented filament nonwoven fabric is integrated with the felt-like fiber body 51, which will be described later, and thus, a partial failure in joining (failure in adhesion) may occur. The grammage may be calculated based, for example, on the average of measured weights of 300 mm×300 mm pieces of the nonwoven fabric. The longitudinally oriented filament nonwoven fabric has a thickness of 15 to 60 μm, preferably 20 to 45 μm.

The long fibers are obtained by melt-spinning a thermoplastic resin. A resin of the same type as the felt-like fiber body 51 is used for the thermoplastic resin. That is, the long fibers are obtained by melt-spinning a polyester resin or a polypropylene resin. Here, a polyethylene terephthalate having an intrinsic viscosity (IV) of 0.43 to 0.63 (preferably 0.48 to 0.58) is preferred as the polypropylene resin, although it is not limited to this. The polyester resin or polypropylene resin may contain additives such as an antioxidant, a weathering agent, and a coloring agent in an amount of about 0.01 to 2% by weight. Additionally, or alternatively, a flame-retardant polyester may be used as the polyester resin.

Next, an example of a method of manufacturing the longitudinally oriented filament nonwoven fabric will described. The method of manufacturing the longitudinally oriented filament nonwoven fabric includes the steps of: forming a nonwoven web including a plurality of long fibers arranged and oriented in the longitudinal direction, and obtaining a longitudinally oriented filament nonwoven fabric by drawing the formed nonwoven web (that is, the plurality of long fibers arranged and oriented in the longitudinal direction) in the longitudinal direction.

Specifically, the step of forming the nonwoven web includes: extruding the plurality (large number) of filaments from the set of nozzles onto the conveyor belt; allowing the filaments extruded from the set of nozzles to accompany the high-speed airstream so as to reduce the filament diameter; and periodically varying the direction of the high-speed airstream in the travel direction of the conveyor belt (that is, in the longitudinal direction). Through these steps, a nonwoven web including a plurality of filaments arranged and oriented in the travel direction of the conveyor belt (that is, in the longitudinal direction) is formed. In the step of obtaining the longitudinally oriented filament nonwoven fabric, the nonwoven web formed is drawn in the longitudinal direction so as to obtain the longitudinally oriented filament nonwoven fabric. The drawing ratio is in the range of 3 to 6 as described above.

Here, regarding the set of nozzles, the number of nozzles, the nozzle hole pitch P, the nozzle hole diameter D, and the nozzle hole length L may be set as desired. Preferably, the nozzle hole diameter D may be in the range of 0.1 to 0.3 mm and the value L/D may be in the range of 10 to 40.

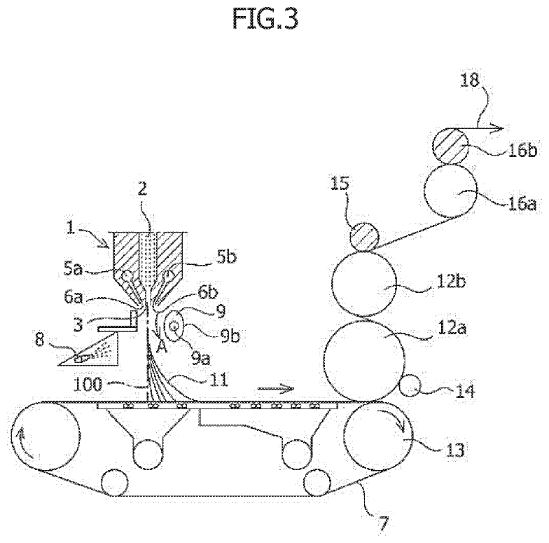

FIG. 3 is a view showing a schematic configuration of an example of a manufacturing apparatus of the longitudinally oriented filament nonwoven fabric. The manufacturing apparatus of the longitudinally oriented filament nonwoven fabric shown in FIG. 3 is configured to manufacture the longitudinally oriented filament nonwoven fabric by meltblowing process, and includes a meltblowing die 1, a conveyor belt 7, an airstream vibration mechanism 9, drawing cylinders 12a, 12b, take-up nip rollers 16a, 16b, and the like.

First, at the upstream end of the manufacturing apparatus, a thermoplastic resin (a polyester resin, in this example) is introduced into an extruder (not shown) and melted and extruded by the extruder. Then, the extruded thermoplastic resin is passed to the meltblowing die 1.

The meltblowing die 1 has a large number of nozzles 3 at its distal end (lower end). The nozzles 3 are lined up in a direction orthogonal to the plane of FIG. 3, that is, in a direction orthogonal to the travel direction of the conveyor belt 7. The molten resin 2 passed to the meltblowing die 1 by a gear pump (not shown) or the like is extruded from the nozzles 3, so that a large number of filaments 11 are formed (spun). Note that FIG. 3, which is a cross-sectional view of the meltblowing die 1, shows only one of the nozzles 3. The meltblowing die 1 includes air reservoirs 5a, 5b provided on the opposite sides of each nozzle 3. High-pressure air heated to a temperature equal to or higher than the melting point of the thermoplastic resin is fed into these air reservoirs 5a, 5b, and then jetted from slits 6a, 6b. The slits 6a, 6b communicate with the air reservoirs 5a, 5b and open to the distal end of the meltblowing die 1. As a result of air jetting, a high-speed airstream substantially parallel to the extrusion direction of the filaments 11 from the nozzles 3 is formed below the nozzles 3. This high-speed airstream maintains the filaments 11 extruded from the nozzles 3 in a draftable molten state. The high-speed airstream applies frictional forces to the filaments 11 to draft the filaments 11 and reduce the diameter of the filaments 11. The diameter of the filaments 11 immediately after being spun is preferably 10 μm or less. The high-speed airstream formed below the nozzles 3 has a temperature higher than the temperature for spinning the filaments 11 by 20° C. or more, preferably by 40° C. or more.

In the method of forming the filaments 11 with the meltblowing die 1, the temperature of the high-speed airstream can be increased such that the temperature of the filaments 11 immediately after being extruded from the nozzles 3 is sufficiently higher than the melting point of the filaments 11, and this allows reduction of the diameter of the filaments 11.

The conveyor belt 7 is disposed below the meltblowing die 1. The conveyor belt 7 is wound around conveyor rollers 13 and other rollers configured to be rotated by a driver (not shown). By rotating the conveyor rollers 13 to drive the conveyor belt 7 to move, the filaments 11 extruded from the nozzles 3 and collected on the conveyor belt 7 are conveyed in the arrow direction (right direction) of FIG. 3.

The airstream vibration mechanism 9 is provided at a predetermined location between the meltblowing die 1 and the conveyor belt 7, specifically, at (a location near) a space through which a high-speed airstream flows. Here, the high-speed airstream is a combination of the high-pressure heated air flows that are jetted from the opposite slits 6a, 6b of the nozzles 3. The airstream vibration mechanism 9 has an elliptical cylindrical portion having an elliptical cross section, and support shafts 9a extending from the opposite ends of the elliptical cylindrical portion. The airstream vibration mechanism 9 is disposed substantially orthogonal to the direction in which the filaments 11 are conveyed by the conveyor belt 7 (the travel direction of the conveyor belt 7), that is, disposed substantially in parallel to the width direction of the longitudinally oriented long-fiber nonwoven fabric to be manufactured. The airstream vibration mechanism 9 is configured such that the elliptical cylindrical portion rotates in the direction of arrow A as the support shafts 9a are rotated. Disposing and rotating the elliptical cylindrical airstream vibration mechanism 9 near the high-speed airstream allows the direction of the high-speed airstream to be changed by the Coanda effect, as will be described later. It should be noted that the present invention is not limited to the manufacturing apparatus having a single airstream vibration mechanism 9, and the manufacturing apparatus may have a plurality of airstream vibration mechanisms 9, as necessary, to increase the vibration amplitude of the filaments 11.

The filaments 11 flow along the high-speed airstream. The high-speed airstream, which is a combination of the high-pressure heated air flows that are jetted from the slits 6a, 6b, flows in a direction substantially orthogonal to the conveying surface of the conveyor belt 7. In this connection, it is generally known that when there is a wall near the high-speed jet flow of gas or liquid, the jet flow tends to pass near surfaces of the wall. Such a phenomenon is called the Coanda effect. The airstream vibration mechanism 9 uses this Coanda effect to change the direction of the high-speed airstream, and thus, the flow of the filaments 11.

It is desirable that the width of the airstream vibration mechanism 9 (the elliptical cylindrical portion), that is, the length of the airstream vibration mechanism 9 in the direction parallel to the support shafts 9a, be greater than the width of the filament set to be spun by the meltblowing die 1 by 100 mm or more. If the width of the airstream vibration mechanism 9 were smaller than the above, the airstream vibration mechanism 9 would fail to sufficiently change the flow direction of the high-speed airstream at the opposite ends of the filament set, and thus, the filaments 11 would not be oriented satisfactorily in the longitudinal direction at the opposite ends of the filament set. The minimum distance between a circumferential wall surface 9b of the airstream vibration mechanism 9 (the elliptical cylindrical portion) and the axis 100 of the high-speed airstream is 25 mm or less, preferably 15 mm or less. If the minimum distance between the airstream vibration mechanism 9 and the airstream axis 100 were greater than the above, the effect of attracting the high-speed airstream to the airstream vibration mechanism 9 would be reduced, and the airstream vibration mechanism 9 would fail to vibrate the filaments 11 satisfactorily.

Here, the vibration amplitude of the filaments 11 depends on the speed of the high-speed airstream and the rotation speed of the airstream vibration mechanism 9. Accordingly, the speed of the high-speed airstream is set to 10 m/sec or more, preferably 15 m/sec or more. If the speed of the high-speed airstream were lower than the above, the high-speed airstream would not be attracted satisfactorily to the circumferential wall surface 9b of the airstream vibration mechanism 9, and the airstream vibration mechanism 9 would fail to vibrate the filaments 11 satisfactorily. The rotation speed of the airstream vibration mechanism 9 may be set to a value ensuring that the vibration frequency that maximizes the vibration amplitude of the filaments 11 is achieved at the circumferential wall surface 9b. Such a maximizing vibration frequency, which varies depending on the spinning conditions, is determined appropriately according to the spinning conditions.

In the manufacturing apparatus shown in FIG. 3, spray nozzles 8 are provided between the meltblowing die 1 and the conveyor belt 7. The spray nozzles 8 are configured to spray water mist or the like into the high-speed airstream. The filaments 11 are cooled and rapidly solidified by the water mist or the like sprayed by the spray nozzles 8. Note that, to avoid unnecessary complications, FIG. 3 shows only one of the spray nozzles 8, although there are actually multiple nozzles.

The solidified filaments 11 are vibrated in the longitudinal direction in the course of being stacked onto the conveyor belt 7, and successively collected on the conveyor belt 7 with end portions folded back in the longitudinal direction. The filaments 11 on the conveyor belt 7 are conveyed in the arrow direction (right direction) of FIG. 3 by the conveyor belt 7, then they are nipped by a presser roller 14 and drawing cylinder 12a heated to the drawing temperature, and then they are transferred onto the drawing cylinder 12a. Thereafter, the filaments 11 are nipped by the drawing cylinder 12b and a presser rubber roller 15, and transferred onto the drawing cylinder 12b. As a result, the filaments 11 are held tight between these two drawing cylinders 12a, 12b. By conveying the filaments 11 held tight between the drawing cylinders 12a, 12b, adjacent ones of the filaments 11 that are partially folded back in the longitudinal direction are fused to each other to produce a nonwoven web.

After that, the nonwoven fabric is taken up by the take-up nip rollers 16a, 16b (the downstream take-up nip roller 16b is made of rubber). The circumferential speed of the take-up nip rollers 16a, 16b is set greater than the circumferential speed of the drawing cylinders 12a, 12b. As a result, the nonwoven web is longitudinally drawn to be 3 to 6 times longer than the original length. In this way, a longitudinally oriented filament nonwoven fabric 18 is manufactured. If necessary, the nonwoven web may further be subjected to a post-processing including heating or partial bonding such as heat embossing or the like. Here, the drawing ratio can be defined, for example, using marks applied at regular intervals on the nonwoven web before drawing the filaments by the following equation: Drawing ratio=“distance between the marks after drawing”/“distance between the marks before drawing”.

As described above, the average diameter of the filaments (long fibers) constituting the longitudinally oriented filament nonwoven fabric 18 thus manufactured is in the range of 1 to 4 μm (preferably 2 to 3 μm). The longitudinally oriented filament nonwoven fabric 18 may have an elongation percentage in the range of 1 to 20%, preferably 5 to 15% in the direction parallel to the filaments, that is, in the longitudinal direction which coincides with the axial direction and the drawing direction of the filaments (long fibers). That is, the longitudinally oriented filament nonwoven fabric 18 may be elastic in the longitudinal direction. The tensile strength in the longitudinal direction of the longitudinally oriented filament nonwoven fabric is 20 N/50 mm or more. The elongation percentage and tensile strength are measured by JIS L1096 8.14.1 A-method.

### Unidirectionally Oriented Nonwoven Fabric (Transversely Oriented Filament Nonwoven Fabric)

A transversely oriented filament nonwoven fabric, which is another example of the unidirectionally oriented nonwoven fabric, is obtained by arranging and orienting a plurality of long fibers made of a thermoplastic resin in the transverse direction, that is, so that the length direction (axial direction) of each long fiber substantially coincides with the transverse direction, and drawing these arranged and oriented long fibers in the transverse direction. In the transversely oriented filament nonwoven fabric, molecules in each long fiber are oriented in the transverse direction. Here, the transverse drawing ratio of each of the long fibers is in the range of 3 to 6. Furthermore, the average diameter of the long fibers constituting the transversely oriented filament nonwoven fabric (i.e., the long fibers after drawing) is in the range of 1 to 4 μm, preferably in the range of 2 to 3 μm. The thermoplastic resin is the same as the thermoplastic resin in the case of the longitudinally oriented filament nonwoven fabric.

### Orthogonally Oriented Nonwoven Fabric

An orthogonally oriented nonwoven fabric is formed by any one of: stacking and fusing the longitudinally oriented filament nonwoven fabric and the transversely oriented filament nonwoven fabric together; stacking and fusing two sheets of the longitudinally oriented filament nonwoven fabric together in an arrangement in which one of the sheets is rotated by 90° with respect to the other; and stacking and fusing two sheets of the transversely oriented filament nonwoven fabric together in an arrangement in which one of the sheets is rotated by 90° with respect to the other. The fusing method used herein is not particularly limited, and fusion is generally through thermal compression using an embossing roller or the like.

### Sound Absorbing Material 50

As described above, the sound absorbing material 50 is configured by integrating the felt-like fiber body 51 with the nonwoven fabric 52. In this embodiment, the felt-like fiber body 51 and nonwoven fabric 52 are integrated by joining (adhering) them with the thermoadhesive fibers of the same kind as the felt-like fiber body 51 and nonwoven fabric 52, that is, the polyester-based thermoadhesive fibers or polypropylene-based thermoadhesive fibers.

Furthermore, the sound absorbing material 50 is manufactured by forming a laminate in which the nonwoven fabric 52, the thermoadhesive web containing the thermoadhesive fibers, and the mixed fiber web (felt-like fiber body 51) are laminated, in this order, and by heat-treating the formed laminate for integration. Specifically, the method for manufacturing the sound absorbing material 50 includes the steps of mixing the fine fibers, the hollow fibers and the binder fibers to obtain mixed fibers (mixing step), opening and carding the mixed fibers to form a mixed fiber web (carding step), conveying a first laminate in which the thermoadhesive web is laminated on the nonwoven fabric 52 (conveying step), laminating the mixed fiber web on the thermoadhesive web of the first laminate to form a second laminate (laminating step), and heat-treating and integrating the second laminate with hot air (heating step).

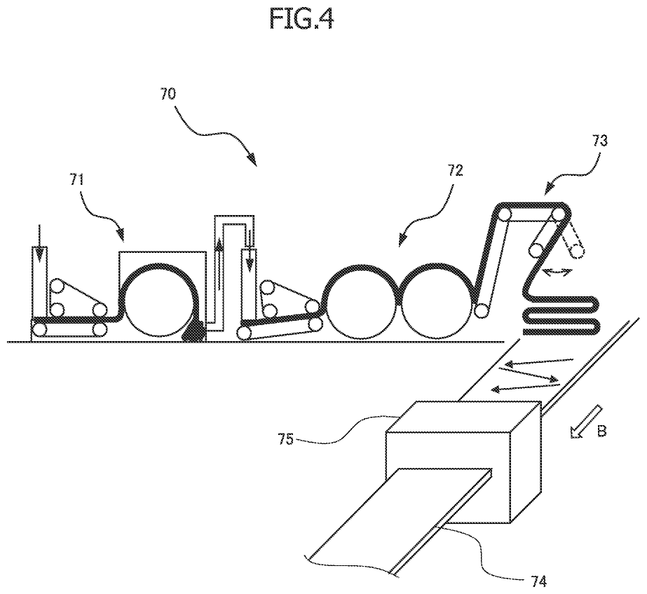

FIG. 4 is a view showing a schematic configuration of an example of a manufacturing apparatus of the sound absorbing material 50. The manufacturing apparatus 70 of the sound absorbing material 50 shown in FIG. 4 includes a fiber blending machine 71, a carding device 72, a web feeding device 73, a conveyor belt 74, a hot air furnace 75, and the like.

The mixing step is mainly performed in the fiber blending machine 71. The fiber blending machine 71 uniformly mixes the introduced fine fibers, the hollow fibers, and the binder fibers to obtain the mixed fibers, and feeds the mixed fibers to the carding device 72.

The carding step is mainly performed in the carding device 72. The carding device 72 opens and cards the mixed fibers that is fed from the fiber blending machine 71 to form the mixed fiber web.

The web feeding device 73 feeds the formed mixed fiber web onto the conveyor belt 74. In this embodiment, the mixed fiber web is fed by the web feeding device 73 to reciprocate in the width direction of the conveyor belt 74, that is, to be distributed in the width direction. Here, the conveyor belt 74 conveys the first laminate in which the thermoadhesive web is laminated on the nonwoven fabric 52 in the direction of arrow B in FIG. 4, and the mixed fiber web that is fed by the web feeding device 73 is laminated on the thermoadhesive web of the first laminate. As a result, the second laminate in which the nonwoven fabric 52, the thermoadhesive web, and the mixed fiber web are laminated in this order is formed on the conveyor belt 74, and the formed second laminate is conveyed by the conveyor belt 74. That is, the laminating step is mainly performed in the web feeding device 73, and the conveying step is performed by the conveyor belt 74.

The heating step is performed in the hot air furnace 75. The hot air furnace 75 is provided in the middle of the conveyor belt 74. The hot air furnace 75 blows hot air from above onto the second laminate which is conveyed by the conveyor belt 74. At this time, the second laminate is absorbed from the back surface side of the conveyor belt 74 by the suction device (not shown). As a result, the binder fibers in the mixed fiber web are melted so that the fibers constituting the felt-like fiber body 51 are joined together (that is, the felt-like fiber body 51 is integrated). Furthermore, the thermoadhesive web is melted so that the felt-like fiber body 51 and the nonwoven fabric 52 are joined together (the sound absorbing material 50 is formed). That is, integrating the felt-like fiber body 51 and joining the felt-like fiber body 51 and the nonwoven fabric 52 (forming the sound absorbing body 50) are performed at the same time in the hot air furnace 75. Although not shown, the sound absorbing material 50 is then cut to a desired width and/or wound into a roll shape as needed.

Here, the grammage of the thermoadhesive web that is used for joining the felt-like fiber body 51 and the nonwoven fabric 52 is about 15 g/m². The thickness of the sound absorbing material 50 to be formed is in the range of 8 to 45 mm, the grammage of the sound absorbing material 50 is in the range of 100 to 500 g/m², and the bulk density of the sound absorbing material 50 is 20 kg/m³ or less, preferably in the range of 8 to 16 kg/m³.

### EXAMPLES

Hereinafter, the sound absorbing material according to the present invention will be described via examples. Note, however, that the present invention is not limited by the following examples.

### Nonwoven Fabric 52

The nonwoven fabric 52 (unidirectionally oriented nonwoven fabric) was produced using the manufacturing apparatus shown in FIG. 3. A meltblowing die 1 having spinning nozzles with a nozzle diameter of 0.15 mm, a nozzle pitch of 0.5 mm, L/D (“nozzle hole length”/“nozzle hole diameter”)=20, and a spinning width of 500 mm was used. The meltblowing die was disposed orthogonal to the travel direction of the conveyor belt. As a filament material (thermoplastic resin), a polyethylene terephthalate (PET) having a melting point of 260° C. was used. Filaments were extruded from the meltblowing die 1 with a discharge rate of 40 g/min per nozzle and a die temperature of 295° C. The high-speed airstream with a temperature of 400° C. and a flow rate of 0.4 m³/min was generated for drafting the filaments extruded from the nozzles 3 to reduce the filament diameter. The filaments were cooled by water mist or the like sprayed by the spray nozzles 8. The airstream vibration mechanism 9 was disposed so that the minimum distance from a vertical extension of each nozzle 3 of the meltblowing die 1 was 20 mm. The airstream vibration mechanism 9 was rotated at 900 rpm (which produced the vibration frequency of 15.0 Hz on the circumferential wall surface of the airstream vibration mechanism 9). As a result, the filaments oriented in the longitudinal direction were collected on the conveyor belt 7. The filaments collected on the conveyor belt 7 were heated and longitudinally drawn to be 4.5 times longer than the original length by the drawing cylinders 12a, 12b. In this way, a PET filament nonwoven fabric was produced. Specifically, by appropriately adjusting mainly the travel speed of the conveyor belt 7, a PET filament nonwoven fabric having a grammage of 5 to 40 g/m² was produced.

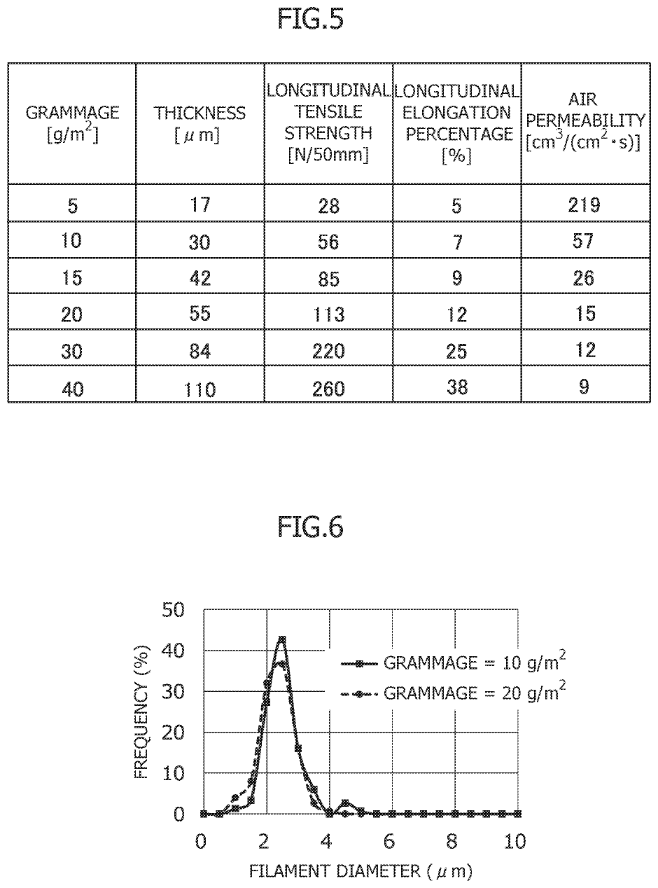

FIG. 5 shows the physical properties of the resulting PET filament nonwoven fabric. FIG. 6 shows the filament diameter distribution of a PET filament nonwoven fabric having a grammage of 10 g/m² and the filament diameter distribution of a PET filament nonwoven fabric having a grammage of 20 g/m². As shown in FIG. 6, in both types of PET filament nonwoven fabric having a grammage of 10 g/m² and PET filament nonwoven fabric having a grammage of 20 g/m², the mode value of the filament diameter distribution of the constituent fibers (long fibers) was about 2.5 μm and the average filament diameter was also about 2.5 μm. It is considered that, in the PET filament nonwoven fabric having other grammage, the filament diameter distribution and average filament diameter of constituent fibers would be substantially the same as those of FIG. 6 since such variations in grammage can be obtained simply by changing the travel speed of the conveyor belt 7 during manufacture.

As shown in FIG. 5, the PET filament nonwoven fabric having a grammage of 5 g/m² or more has a sufficient strength. Furthermore, in the manufacturing apparatus 70 shown in FIG. 4, the laminate in which the PET filament nonwoven fabric having each grammage (in the range of 5 to 40 g/m²), the thermoadhesive web, and the mixed fiber web (felt-like fiber body 51) are laminated was conveyed by the conveyor belt 74 and passed through the hot air furnace 75 to check joining (adhesiveness) between the PET filament nonwoven fabric and the mixed fiber web (felt-like fiber body 51). As a result, the PET filament nonwoven fabric having a grammage in the range of 5 to 20 g/m² was joined (adhered) to the felt-like fiber body 51 without any problem, but the PET filament nonwoven fabric having a grammage in the range of 30 to 40 g/m² partially had poor joining (adhesion) with the felt-like fiber body 51. Therefore, the PET filament nonwoven fabric having a grammage of 5 to 20 g/m² and/or the PET filament nonwoven fabric having the thickness of 15 to 60 μm are preferred from the perspective of manufacture.

### Examples and Comparative Examples

The sound absorbing material 50 (Examples 1 to 5 below) was produced by using the manufacturing apparatus shown in FIG. 4, and the felt-like fiber body 51 (Comparative Examples 1 to 5 below) was produced by feeding the mixed fiber web on the conveyor belt on which no nonwoven fabric 52 or thermoadhesive web exists.

### Example 1

The mixed fiber web (felt-like fiber body 51) having a grammage of 120 g/m² was formed by mixing 40% by weight of PET fine fibers (fine fibers) with a fineness of 0.9 denier, 30% by weight of hollow PET fibers (hollow fibers) with a fineness of 7 denier, and 30% by weight of low-melting point PET fibers (binder fibers) with a fineness of 4 denier. Furthermore, the PET filament nonwoven fabric having a grammage of 15 g/m² was used as the nonwoven fabric 52, and the fiber web having a grammage of 15 g/m² which includes the low-melting point PET fibers was used as the thermoadhesive web. These were heat-treated in the hot air furnace to obtain the sound absorbing material 50. The sound absorbing material 50 obtained had a thickness of 11 mm, a bulk density of 14 kg/m³, and a grammage of 150 g/m².

### Example 2

The mixed fiber web (felt-like fiber body 51) having a grammage of 235 g/m² was formed by mixing 30% by weight of PET fine fibers with a fineness of 0.5 denier, 40% by weight of hollow PET fibers with a fineness of 7 denier, and 30% by weight of low-melting point PET fibers with a fineness of 2 denier. Furthermore, the PET filament nonwoven fabric having a grammage of 15 g/m² was used as the nonwoven fabric 52, and the fiber web having a grammage of 15 g/m², which includes the low-melting point PET fibers, was used as the thermoadhesive web. These were heat-treated in the hot air furnace to obtain the sound absorbing material 50. The sound absorbing material 50 obtained had a thickness of 23 mm, a bulk density of 12 kg/m³, and a grammage of 265 g/m².

### Example 3

The mixed fiber web (felt-like fiber body 51) having a grammage of 300 g/m² was formed by mixing 40% by weight of PET fine fibers with a fineness of 0.9 denier, 30% by weight of hollow PET fibers with a fineness of 7 denier, and 30% by weight of low-melting point PET fibers with a fineness of 4 denier. Furthermore, the PET filament nonwoven fabric having a grammage of 15 g/m² was used as the nonwoven fabric 52, and the fiber web having a grammage of 15 g/m² which includes the low-melting point PET fibers was used as the thermoadhesive web. These were heat-treated in the hot air furnace to obtain the sound absorbing material 50. The sound absorbing material 50 obtained had a thickness of 28 mm, a bulk density of 12 kg/m³, and a grammage of 330 g/m².

### Example 4

The mixed fiber web (felt-like fiber body 51) having a grammage of 300 g/m² was formed by mixing 20% by weight of PET fine fibers with a fineness of 0.9 denier, 50% by weight of hollow PET fibers with a fineness of 7 denier, and 30% by weight of low-melting point PET fibers with a fineness of 4 denier. Furthermore, the PET filament nonwoven fabric having a grammage of 15 g/m² was used as the nonwoven fabric 52, and the fiber web having a grammage of 15 g/m² which includes the low-melting point PET fibers was used as the thermoadhesive web. These were heat-treated in the hot air furnace to obtain the sound absorbing material 50. The sound absorbing material 50 obtained had a thickness of 35 mm, a bulk density of 9.4 kg/m³, and a grammage of 330 g/m².

### Example 5

The mixed fiber web (felt-like fiber body 51) having a grammage of 380 g/m² was formed by mixing 30% by weight of PET fine fibers with a fineness of 0.9 denier, 40% by weight of hollow PET fibers with a fineness of 7 denier, and 30% by weight of low-melting point PET fibers with a fineness of 4 denier. Furthermore, the PET filament nonwoven fabric having a grammage of 15 g/m² was used as the nonwoven fabric 52, and the fiber web having a grammage of 15 g/m² which includes the low-melting point PET fibers was used as the thermoadhesive web. These were heat-treated in the hot air furnace to obtain the sound absorbing material 50. The sound absorbing material 50 obtained had a thickness of 40 mm, a bulk density of 12 kg/m³, and a grammage of 410 g/m².

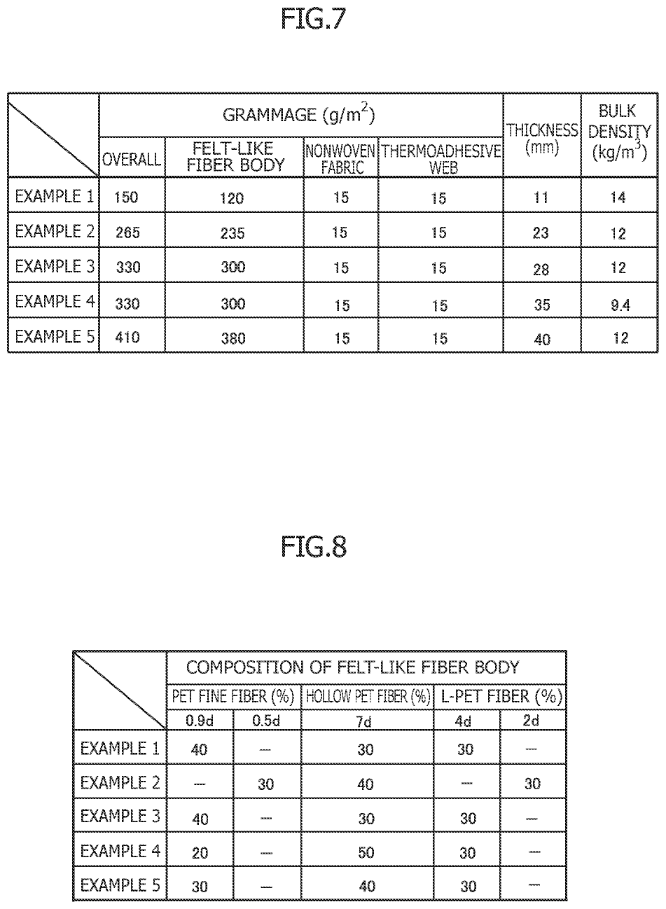

FIG. 7 shows the characteristic values (grammage, thickness and bulk density) of Examples 1 to 5, and FIG. 8 shows the mixing ratio of the PET fine fibers, hollow PET fibers, and low-melting point PET fibers in the mixed fiber web (felt-like fiber body 51) of Examples 1 to 5.

### Comparative Examples 1 to 5

Comparative Examples 1 to 5 were prepared by heat-treating only the mixed fiber webs (felt-like fiber bodies 51) of Examples 1 to 5 in the hot air furnace.

It was confirmed that all of Examples 1-5 were light in weight, flexible enough, and easy enough to handle. It was also confirmed that none of Examples 1-5 caused problems such as a failure in joining (failure in adhesion) and could be easily and stably manufactured by the manufacturing apparatus, as shown in FIG. 4.

### Sound Absorption Test

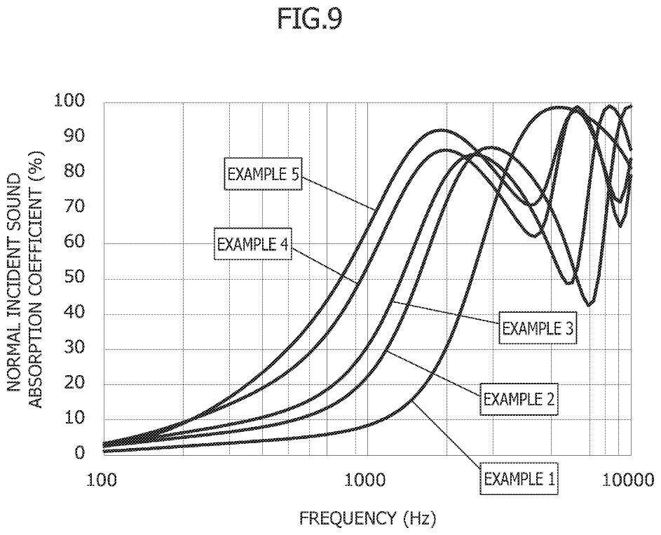

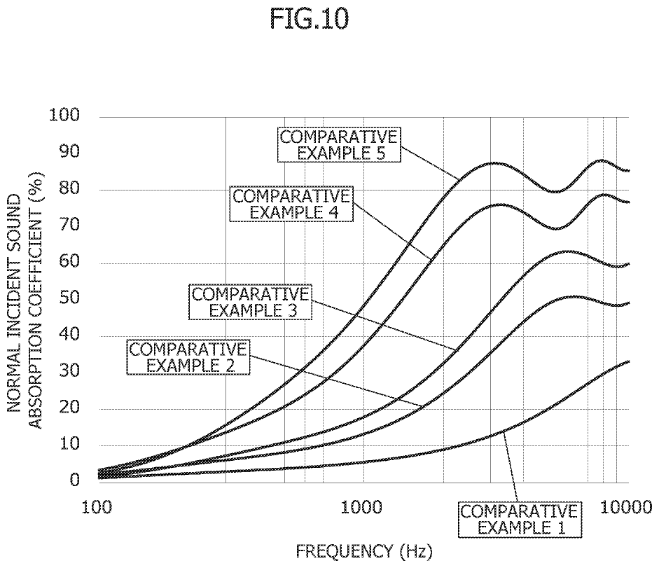

Using the normal incident sound absorption coefficient measurement system WinZacMTX manufactured by Nihon Onkyo Engineering Co., Ltd., the normal incident sound absorption coefficient was measured as specified in JIS A1405-2 for each of Examples 1 to 5 and Comparative Examples 1 to 5. FIG. 9 shows the measurements of the normal incident sound absorption coefficient for Examples 1 to 5. FIG. 10 shows the measurements of the normal incident sound absorption coefficient for Comparative Examples 1 to 5.

It was confirmed that Example 1 has significantly improved sound absorption performance at 2000 to 10000 Hz, obtains a very high sound absorption coefficient at 3500 to 8500 Hz, and has a sound absorption peak at 5000 to 6000 Hz as compared to Comparative Example 1.

It was confirmed that Example 2 had significantly improved sound absorption performance at 1500 to 6000 Hz, yielded a very high sound absorption coefficient at 2500 to 4000 Hz, and had a sound absorption peak at around 3000 Hz as compared to Comparative Example 2.

It was confirmed that Example 3 had significantly improved sound absorption performance at 1500 to 5000 Hz, yielded a very high sound absorption coefficient at 2500 to 4000 Hz, and had a sound absorption peak at around 2500 Hz as compared to Comparative Example 3.

It was confirmed that Example 4 had significantly improved sound absorption performance at 1500 to 2500 Hz and 5000 to 7000 Hz and yielded a very high sound absorption coefficient, and had a sound absorption peak at around 2000 Hz and 6500 Hz as compared to Comparative Example 4.

It was confirmed that Example 5 had significantly improved sound absorption performance at 1500 to 2500 Hz and 5000 to 7000 Hz and yielded a very high sound absorption coefficient, and had a sound absorption peak at around 2000 Hz and 6500 Hz as compared to Comparative Example 5.

Here, according to the measurements of the normal incident sound absorption coefficient for Examples 1 to 5, the sound absorption peak shifts towards a lower frequency as the thickness of the felt-like fiber body 51 increases. That is, the sound absorbing material providing high sound absorption performance in a predetermined frequency band of 10000 Hz or less can be obtained by combining the felt-like fiber bodies having different thicknesses with the same nonwoven fabric (the PET filament nonwoven fabric of 15 g/m²). In other words, a more effective sound absorbing material can be obtained by selecting the felt-like fiber body having an appropriate thickness according to the frequency band of 10000 Hz or less to be absorbed.

As described above, the sound absorbing material comprises: a felt-like fiber body which includes 15 to 70% by weight of fine fibers with a fineness of 1 denier or less, 20 to 60% by weight of hollow fibers, and 10 to 40% by weight of binder fibers; and a nonwoven fabric that is laminated on the surface of the felt-like fiber body, the nonwoven fabric including a plurality of drawn long fibers arranged and oriented in one direction, and having an average diameter of the plurality of long fibers in the range of 1 to 4 μm and a grammage in the range of 5 to 20 g/m², wherein the sound absorbing material has a thickness in the range of 8 to 45 mm and a bulk density of 20 kg/m³ or less. Such sound absorbing material is light in weight, easy to handle, easy to stably manufacture, and capable of providing high sound absorption performance in a predetermined frequency band of 10000 Hz or less.

The sound absorbing material according to the present invention may be used in a variety of applications. Example applications of the sound absorbing material according to the present invention include a sound absorbing material for an engine compartment and for an interior of an automobile, a sound absorbing protective material for automobiles, for household electrical appliances, and for various motors, etc., a sound absorbing material to be installed in walls, floors, ceilings, etc. of various buildings, a sound absorbing material for interior use in machine rooms etc., a sound absorbing material for various sound insulating walls, and/or a sound absorbing material for office equipment such as copiers and multifunction machines.

### REFERENCE SYMBOL LIST

50 Sound absorbing material
51 Felt-like fiber body
52 Nonwoven fabric
70 Manufacturing apparatus of the sound absorbing material
71 Fiber blending machine
72 Carding device
73 Web feeding device
74 Conveyor belt
75 Hot air furnace

1. A sound absorbing material comprising:
a felt-like fiber body which includes 15 to 70% by weight of fine fibers with a fineness of 1 denier or less, 20 to 60% by weight of hollow fibers having inner cavities, and 10 to 40% by weight of binder fibers that join the fibers together; and
a nonwoven fabric that is laminated on a surface of the felt-like fiber body, the nonwoven fabric including a plurality of drawn long fibers arranged and oriented in one direction, and having an average diameter of the plurality of long fibers in the range of 1 to 4 μm and a grammage in the range of 5 to 20 g/m²,
wherein the sound absorbing material has a thickness in the range of 8 to 45 mm and a bulk density of 20 kg/m³ or less.

2. The sound absorbing material according to claim 1, wherein a grammage of the sound absorbing material is in the range of 100 to 500 g/m².

3. The sound absorbing material according to claim 1, wherein a fineness of the hollow fibers is greater than that of the fine fibers and is 15 denier or less, and a fineness of the binder fibers is greater than that of the fine fiber and is 6 denier or less.

4. The sound absorbing material according to claim 1, wherein the hollow fibers account for the highest weight ratio among the fine fibers, the hollow fibers and the binder fibers.

5. The sound absorbing material according to claim 1, wherein the felt-like fiber body and the nonwoven fabric are joined by thermoadhesive fibers.

6. The sound absorbing material according to claim 5, wherein the fine fibers, the hollow fibers, the binder fibers, the long fibers and the thermoadhesive fibers are polyester fibers mainly containing a polyester.
